(19) United States
(12) Patent Application Publication
(10) Pub. No.: US 2011/0164481 A1
(43) Pub. Date: Jul. 7, 2011

(54) RECORDING METHOD FOR OPTICAL DISC AND OPTICAL DISC DEVICE

(75) Inventor: Jaeyong RYU, Seoul (KR)

(73) Assignee: HITACHI-LG DATA STORAGE KOREA, INC., Seoul (KR)

(21) Appl. No.: 12/986,702

(22) Filed: Jan. 7, 2011

(30) Foreign Application Priority Data
Jan. 7, 2010 (KR) 10-2010-0001058

(51) Int. Cl. G11B 7/125

(52) U.S. Cl. 369/44.25; G9B/7.1

(57) ABSTRACT

A recording method for an optical disc and an optical disc device are provided. In one embodiment of the present invention, delay at upward transition of laser diode output driven by a recording pulse can be compared with a predetermined reference value; when the delay is larger than the predetermined reference value, the delay at the upward transition can be compensated by adjusting the recording pulse through a pulse of a reserved output channel; and data can be recorded in an optical disc by driving the laser diode by using the adjusted recording pulse. The amount of delay at the upward transition can be detected through a front photo detector of the laser diode; and the comparison and the compensation can be carried out when fast recording more than specified performance on the optical disc is requested.

### BACKGROUND

1. Field

This document relates to a recording method for an optical disc and an optical disc device. More specifically, this document relates to a method for compensating recording power when recording is performed on an optical disc with recording speed higher than that specified for the disc.

2. Related Art

An optical disc device emits a beam through a laser diode, which is incident on an optical disc. The incident beam is reflected differently according to the form of data (pit or mark) recorded in the optical disc. By detecting the reflected beam by using a photo detector, the optical disc device can read out data recorded in the optical disc. Also, the optical disc device records data on an optical disc by controlling a laser beam corresponding to data to be recorded to emit from the laser diode to be incident on the optical disc.

An optical disc device which is capable of recording forms marks on a recording layer of an optical disc by driving the laser diode with a recording pulse signal corresponding to a mark to be recorded. The optical disc device, to record a large amount of data more quickly (to increase recording speed), rotates the disc with high speed, and drives the laser diode by reducing a time interval between recording pulses, and increasing the height (recording power) of the recording pulse.

In doing so, because of temporal limit (frequency limit) of the recoding pulse and power limit of the laser diode, maximum recording speed of the optical disc device is limited. Also, maximum recording speed of the optical disc is limited, because energy of the laser beam concentrated on the recording layer during high speed rotation should be absorbed to change crystalline state of the recording layer to amorphous marks.

It is often the case that when a user records data in a disc, maximum recording speed of which is 20×, by using an optical disc device capable of recording at 24×, he or she may attempt to apply higher recording speed (for example, 24×) than the maximum recording speed of the disc (which is called over spec. writing). In case of such over spec. writing, since higher energy than that required when the optical disc device capable of 24× recording speed records a disc of 24× recording speed should be delivered to the disc of 20× recording speed, the optical disc device is made to output a recording pulse having higher power than a reliable, guaranteed power value.

As shown in FIG. 1, however, due to the characteristics of a recording pulse signal, the more recording power is increased, elongated is rising time required for the recording pulse signal to rise to a required level at a rising edge where upward transition from a low level to a high level occurs. Due to the delay in upward transition, distortions appear in the rising edge; front overhead power required for fast recording is not pulled out; and due to lack of power, recording quality is degraded or recording failure happens.

### DISCLOSURE

### Technical Problem

The present invention has been made to provide a method for compensating transition delay or distortion occurring at the front part of a recording pulse when a disc undergoes fast recording more than specified performance.

### Technical Solution

A recording method for an optical disc according to one embodiment of the present invention comprises comparing delay at upward transition of laser diode output driven by a recording pulse with a predetermined reference value; when the delay is larger than the predetermined reference value, adjusting the recording pulse through a pulse of a reserved output channel to compensate the delay at the upward transition; and recording data in an optical disc by driving the laser diode by using the adjusted recording pulse.

An optical disc device according to another embodiment of the present invention comprises an optical pick-up comprising a laser diode outputting a laser beam and comprising a front photo detector generating a signal corresponding to output level of the laser beam, and by using the laser diode, reading out data from a data surface of an optical disc or recording data on the data surface thereof; an optical driving unit for applying a recording pulse to the laser diode to make a laser beam emit with a required power level; and a controller configured to to detect delay at upward transition of laser diode output driven by the recording pulse based on a signal output from the front photo detector, compare the delay with a predetermined reference value, and if the delay is larger than the predetermined reference value, and control the optical driving unit to adjust the recording pulse through a pulse of a reserved output channel to compensate the delay at the upward transition.

In one embodiment, the method, if the amount of delay is larger than the predetermined reference value, further comprises adjusting timing of the recording pulse.

In one embodiment, delay can be detected at the upward transition of laser diode output driven by a castle-shaped recording pulse composited by pulses generated at two output channels, and the recording pulse can be adjusted by generating a pulse with a predetermined level and width at around upward transition of the castle-shaped recording pulse from the reserved output channel.

In one embodiment, the delay at the upward transition can be detected through a front photo detector of the laser diode.

In one embodiment, the comparing and the adjusting can be repeated for multiple output levels of a laser diode and the recording pulse adjusted for each output level can be stored.

In one embodiment, the comparing and the adjusting can be carried out when fast recording more than specified performance on the optical disc is requested.

### Advantageous Effects

Therefore, recording failure due to lack of recording power can be prevented even if a disc undergoes fast recording more than specified performance and recording quality can be improved.

### BRIEF DESCRIPTION OF THE DRAWINGS

The implementation of this document will be described in detail with reference to the following drawings in which like numerals refer to like elements.

FIG. 1 illustrates an example where distortion occurs at rising edge of a recording pulse as recording power is increased;

FIG. 2 illustrates a castle-shaped recording pulse reinforced with power at around rising edge and falling edge;

FIG. 3 illustrates a structure related to driving a laser diode of a conventional optical disc device;

FIG. 4 illustrates an example of compensating rising edge of a recording pulse by using reserved output channels according to one embodiment of the present invention;

FIG. 5 illustrates one embodiment of a structure of an optical disc device to which the present invention is applied; and

FIG. 6 is a flow chart of a recording method for an optical disc according to one embodiment of the present invention.

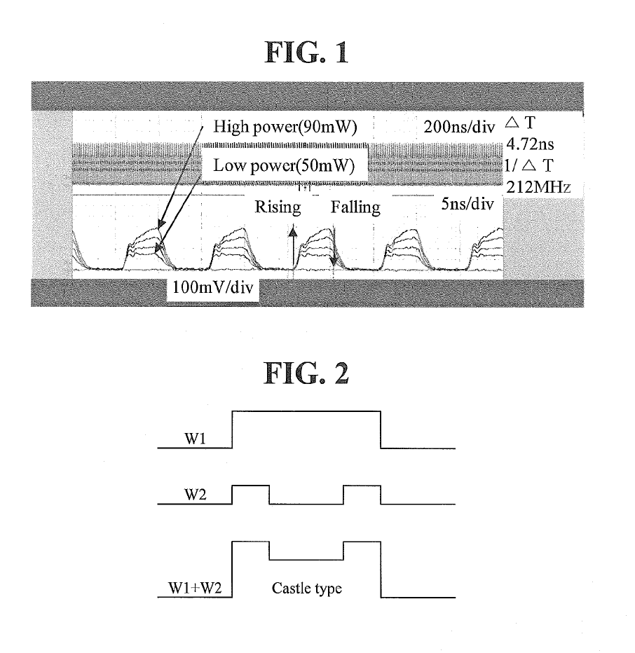

### DETAILED DESCRIPTION

Hereinafter, a recording method for an optical disc and an optical disc device will be described in detail with reference to appended drawings.

An optical disc device, at the time of recording data in a rewritable disc (for example, CD-RW, DVD-RW, and BD-RE), if length of a mark to be recorded is nT, applies (n-1) multi-pulses or n/2 multi-pulses; where a multi-pulse has three different power levels comprising Write Power, Erase Power, and Bottom Power. An optical driving unit inside the optical disc device provides three output channels of W1, W2, and W3; and by combining outputs of the output channels, determines a power level among the three power levels. [0025]The optical disc device, at the time of recording data in a write-once disc (for example, CD-R, DVD-R/DVD+R, and BD-R), applies a single pulse having a length corresponding to that of a mark to be recorded to the laser diode; as shown in FIG. 2, the optical disc device uses a castle-shaped recording pulse reinforced with power at around rising edge and falling edge for the rising edge (or transition) and the falling edge to be formed clearly. The optical driving unit can form a castle-shaped recording pulse for driving the laser diode by using two output channels W1, W2 in the form as shown in FIG. 2.

Meanwhile, the optical disc device records data in optical discs such as CD (Compact Disc), DVD (Digital Versatile Disc), and BD (Blu-ray Disc) by using laser power, where the laser power (recording power) is maintained at a constant level by an automatic power control (APC) circuit inside an RF (Radio Frequency) IC.

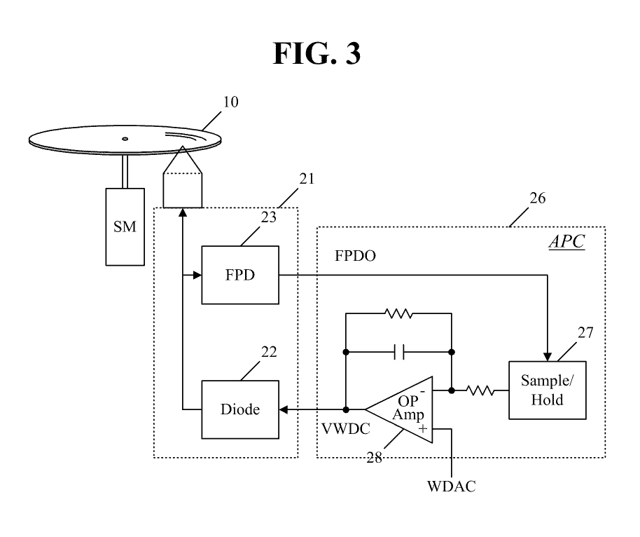

FIG. 3 illustrates a structure related to driving a laser diode of a conventional optical disc device, where an optical pick-up inside the optical disc device can comprise a laser diode 21 and an APC circuit 26. The laser diode 21 comprises a light emitting diode 22 outputting a beam and a front photo detector (FPD) 23 outputting a signal (FPDO) corresponding to the beam output from the light emitting diode 22; the APC circuit 26 comprises a sample/hold circuit 27 and an OP amp 28, thus outputting a recording power voltage (VWDC) of a predetermined magnitude based on a WDAC input voltage and the FPDO signal output from the FPD 23.

The WDAC input voltage corresponds to a value determined to correspond to recording speed or recording power and the FPDO signal is a signal corresponding to a beam output from the light emitting diode 22, which is fed back by the FPD 22. The APC circuit 26, by adjusting and outputting the recording power voltage (VWDC) based on the FPDO signal fed back from the FPD 23 and the WDAC input voltage applied through an external digital/analog converter (DAC), maintains recording power set according to current recording speed at a constant level.

In case of recording data in a disc, WDAC which is a plurality of multi-pulse signals having short time duration or a single pulse signal having a length corresponding to that of a mark to be recorded is input to the light emitting diode 22 according to a write strategy to form each mark; and according thereto, the light emitting diode 22 repeats on-off operation and emits a laser beam.

The FPD 23 outputs a signal corresponding to power level of a beam output by the light emitting diode 22. The FPD 23, to allow power control, measures the output of the light emitting diode 22 with sufficient speed corresponding to the speed at which the light emitting diode 22 is turned on and off by a recording pulse; and outputs a signal corresponding to the measured output.

The optical disc device can check change of output power of the light emitting diode 22 according as time elapses by using a signal output from the FPD 23. Accordingly, the optical disc device, by checking performance of a recording pulse, namely, rising time, falling time, power level, and the like of the recording pulse, can check whether a laser beam is output with sufficient recording power.

The optical disc device, when fast recording more than specified performance is requested, outputs a recording pulse by raising the level thereof to a larger value than a reliable, guaranteed value. In this case, whether large distortion (delay in upward transition) at rising edge of the recording pulse has occurred can be checked by using the FPD 23 output signal.

In particular, if fast recording is requested on a write-once disc more than specified performance, the optical disc device outputs a high power laser beam by generating a castle-shaped recording pulse of high power level by using two output channels (for example, W1 and W2) and driving the light emitting diode 22 by using the castle-shaped recording pulse of high power. If it is found from the FPD 23 output signal that distortion occurs at rising edge of the recording pulse, the rising edge of the recording pulse can be compensated by using a reserved output channel (for example, W3).

In the present invention, therefore, if data are recorded by a single pulse, power of an output laser beam can be detected and distortion at the rising edge of the recording pulse or delay of upward transition can be compensated by using reserved output channels.

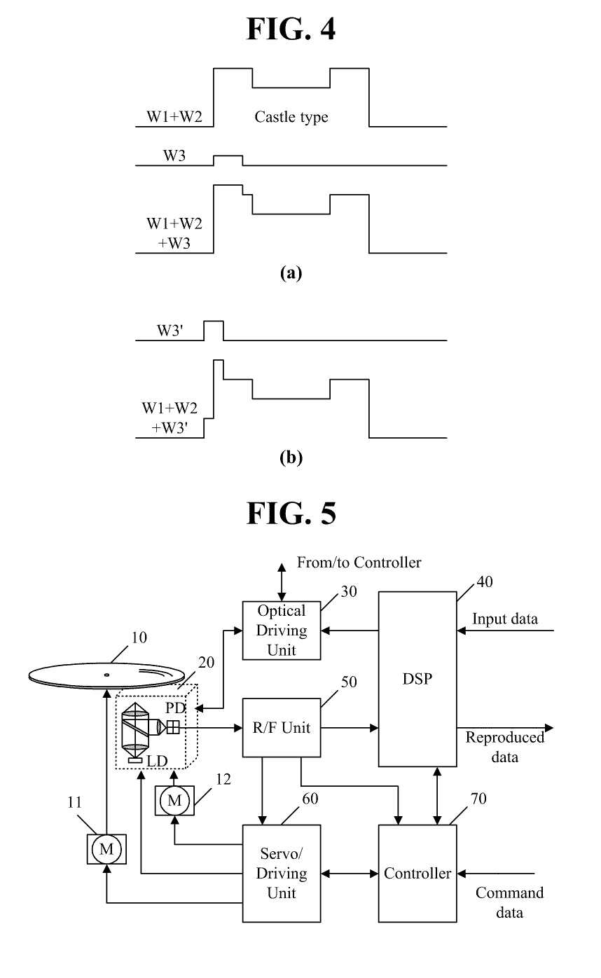

In other words, if fast recording is requested on a write-once disc more than specified performance of the disc, test recording is performed and whether distortion occurs at rising edge is determined by measuring power output from the laser diode; if it is the case that distortion at the rising edge exceeds a reference value, the distortion is compensated by using reserved output channels. In this case, as shown in FIG. 4, the test recording can be repeated by changing the timing, duration, and level of the recording pulse of the reserved output channels.

A recording method for an optical disc according to the present invention can be applied to a disc recording device capable of recording data to optical discs such as CD, DVD, and BD. FIG. 5 illustrates one embodiment of a structure of an optical disc device to which the present invention is applied.

An optical disc device according to the present invention comprises a spindle motor 11; a sled motor 12; an optical pick-up 20 recording and reading out data to and from an optical disc by using a laser beam; a recording/playback unit driving the spindle motor 11, the sled motor 12, and the optical pick-up 20 and processing a servo signal and recording/playback data; and a controller controlling the recording/playback unit. The recording/playback unit may comprise an optical driving unit 30, a digital signal processor (DSP) 40, an R/F unit 50, and a servo/driving unit60, where the optical driving unit 30 can be included in the optical pick-up 20 or the DSP 40.

The DSP 40 converts input digital data into a recording format by adding an error correction code (ECC); an optical driving unit 30 outputs a light quantity driving signal according to an input signal; the optical pick-up 20 records data to an optical disc 10 or reads data from a recording surface of the optical disc 10 according to the light quantity driving signal.

The optical driving unit 30, at the time of recording data in a disc, outputs WDAC which is a recording pulse signal for forming individual marks to the laser diode of the optical pick-up 20; at the time of reading out data from the disc, outputs a level value required for reading out data again to the laser diode of the optical pick-up 20; and carries out power control through an embedded APC circuit to maintain the output power of the laser diode at a constant level.

The R/F unit 50 outputs the signal detected at the optical pick-up 20 as a binary signal by filtering and shaping the detected signal; and also generates and outputs a tracking error signal TE, a focusing error signal FE, an RF signal, and so on. The DSP 40, by using a built-in clock synchronized with the binary signal, restores the binary signal to the original data. The servo/driving unit 60 generates a servo signal required for focusing servo, tracking servo, sled servo, and spindle servo based on the signal from the R/F unit 50; drives the spindle motor 11 which rotates the optical disc 10; drives the sled motor 12 which moves the optical pick-up20 toward the inner and outer circumference of the optical disc 10; and drives a current required for focusing servo and tracking servo of an object lens within the optical pick-up 20.

The controller 70 records or reads out data to and from an optical disc by controlling individual elements; to read out data from the optical disc 10 by controlling the optical driving unit 30, drives a laser diode within the optical pick-up 20 by using playback power; and to record data to the optical disc 10, drives the laser diode by recording power.

In addition, the controller 70, based on an RF signal detected at the optical pick-up 20 and output from the R/F unit 50 and a servo signal, controls the servo/driving unit 60 and drives the spindle motor 11, thereby rotating the optical disc 10 with a speed required, moves the optical pick-up 20 to a required position by driving the sled motor 12, and performs focusing servo and tracking servo by applying a current to an actuator supporting the object lens within the optical pick-up 20.

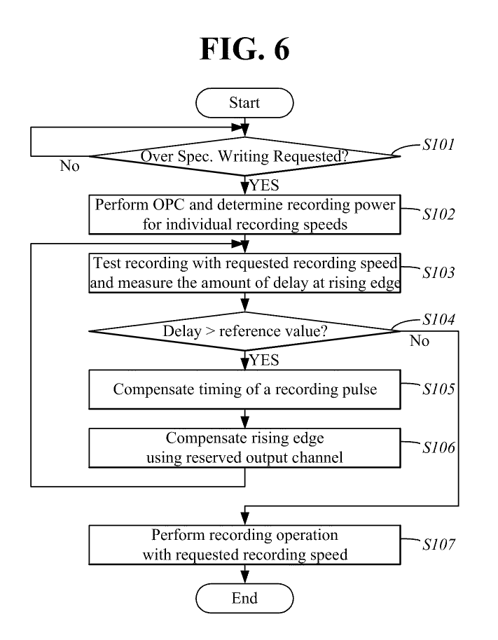

FIG. 6 is a flow chart of a recording method for an optical disc according to one embodiment of the present invention.

The controller 70 of the optical disc device according to the present invention, upon receiving a request for recording data in a loaded optical disc from the user S101, performs OPC (Optimum Power Control) operation at a predetermined area of the optical disc (for example, PCA

(Power Calibration Area) prepared in the inner circumference and/or outer circumference of the disc) by controlling the recording/playback unit comprising the optical driving unit 30, the DSP 40, the R/F unit 50, and the servo/driving unit 60; and detects optimum recording power for each recording speed S102.

In particular, if the user requests data recording with higher recording speed than that allowed for an optical disc (Over Spec. Writing) S101, the controller 70 performs test recording for the requested maximum recording speed by controlling the optical driving unit 30; and while the laser diode of the optical pick-up 20 is driven to a predetermined recording level by a recording pulse having a time width corresponding to the requested recording speed through the sample/hold circuit 27 included in the APC circuit inside the optical driving unit 30, measures the amount of distortion at rising edge due to the recording pulse or the amount of delay during upward transition by measuring a signal output from FPD 23 of the laser diode S103. At this time, a castle-shaped recording pulse through output channels of W1 and W2 as shown in FIG. 2 can be applied for DVD+/-R type discs.

The controller 70, at the time of test recording, applies a recording pulse with higher level than that usually required for recording at requested recording speed to the laser diode and measures output power of the diode 22 emitting light according to the recording pulse through the FPD 23 and the sample/hold circuit 27 with high time resolution. For example, since the time resolution is high enough to allow tens of sampling during a time period corresponding to the width of the recording pulse, rising time at rising edge can be measured with sufficient precision even for a recording pulse with a short time width.

Next, the controller 70 compares the degree of distortion at the rising edge measured through the FPD 23 and the sample/hold circuit 27 with a predetermined reference value (for example, reference distortion with respect to the shortest pulse when recording is carried out at the highest recording speed) S104. For example, the predetermined reference value can be a check value of whether the time required to reach from 10% to 90% of a required output level exceeds a half of time width of 2 T or 3 T which is the shortest recording pulse at the maximum recording speed.

If the degree of distortion at the rising edge is smaller than a predetermined reference value (NO at S104), the controller 70 decides that output of the laser diode driven by a recoding pulse utilizing a single output channel or a recording pulse utilizing two output channels of W1 and W2 has reached a required power level in a sufficiently short time period; and by controlling the optical driving unit 30, the DSP 40, the R/F unit 50, and the servo/driving unit 60 and driving the laser diode with a single output channel or two output channels, can carry out data recording operation with requested recording speed S107.

On the other hand, if the degree of distortion at the rising edge is larger than a predetermined reference value (YES at S104), the controller 70 decides that the output power of the laser beam is not enough to achieve required speed at the rising edge even if the laser diode is driven by a recording pulse generated by using a single output channel or two output channels and having a pulse width and a level corresponding to the recording speed requested from the user; by controlling the optical driving unit 30, first compensates the distortion at the rising edge by adjusting the timing of the pulse generated at an output channel already in use S105; and additionally compensates the distortion at the rising edge of the recording pulse by using the remaining output channels W3, S106. At this time, as shown in FIG. 4, by either outputting a recording pulse having a predetermined level and width at the rising edge in synchronization with the other output channels W1, W2 or outputting a recording pulse having a predetermined level and width ahead of the other output channels, the rising time required for the output of the laser diode to reach a required level can be reduced.

In this manner, while compensating the rising edge and driving the laser diode by adjusting pulse timing of an output channel already in use and additionally using the remaining output channels, the controller 70 measures again the amount of distortion at the rising edge due to the recording pulse by measuring a signal output from the FPD 23 of the laser diode 5103; and again carries out operation of comparing the measured distortion with a predetermined reference value S104. At this time, the S103 to S106 steps can be repeated until the amount of distortion at the rising edge due to the output of the laser diode driven by a compensated recording pulse becomes smaller than a predetermined reference value; the S105 step where adjusted is only the output timing of a recording pulse from an output channel already in use can be omitted.

If the amount of distortion at the rising edge due to the output of the laser diode becomes smaller than a predetermined reference value through S103 to S106 step, the controller 70, by controlling the optical driving unit 30, the DSP 40, the R/F unit 50, and the servo/driving unit 60, can perform data recording operation with requested recording speed while driving a laser diode by using single output channel, two or three output channels S107.

The controller 70, while increasing step by step the level of a recording pulse driving a laser diode, can repeat the S103 to the S106 steps; for example, at the time of attempting data recording for a DVD+R disc with 24× recording speed, the level of the recording pulse can be increased with an increment of 10 mW from a recording pulse for outputting 50 mW to a recording pulse for outputting 90 mW.

Recording pulse composition obtained by combining output channels through the procedure described above can be stored in a non-volatile memory for later use. At the same time, recording pulse composition providing enhanced performance at rising edge can be obtained periodically and stored in the non-volatile memory to update the previous one.

The exemplary embodiments of the present invention described above have been introduced for illustrative purposes only. It should be understood that those skilled in the art would be able to improve, modify, substitute, or add various other embodiments within the technical principles and scope of the present invention as defined by the following appended claims.

What is claimed is:

1. A recording method for an optical disc, comprising:
comparing delay at upward transition of laser diode output driven by a recording pulse with a predetermined reference value;
when the delay is larger than the predetermined reference value, adjusting the recording pulse through a pulse of a reserved output channel to compensate the delay at the upward transition; and
recording data in an optical disc by driving the laser diode by using the adjusted recording pulse.

2. The method of claim 1, if the delay is larger than the predetermined reference value, further comprising adjusting timing of the recording pulse.

3. The method of claim 1, further comprising detecting delay at the upward transition of laser diode output driven by a castle-shaped recording pulse composited by pulses generated at two output channels.

4. The method of claim 3, wherein the recording pulse is adjusted by generating a pulse with a predetermined level and width at around upward transition of the castle-shaped recording pulse from the reserved output channel.

5. The method of claim 1, wherein the amount of delay at the upward transition is be detected through a front photo detector of the laser diode.

6. The method of claim 1, wherein the comparing and the adjusting are repeated for multiple output levels of a laser diode.

7. The method of claim 6, further comprising storing the recording pulse adjusted for each output level.

8. The method of claim 1, wherein the comparing and the adjusting are carried out when fast recording more than specified performance on the optical disc is requested.

9. An optical disc device, comprising:
an optical pick-up comprising a laser diode outputting a laser beam and comprising a front photo detector generating a signal corresponding to output level of the laser beam, and by using the laser diode, reading out data from a data surface of an optical disc or recording data on the data surface thereof;
an optical driving unit for applying a recording pulse to the laser diode to make a laser beam emit with a required power level; and
a controller configured to detect delay at upward transition of laser diode output driven by the recording pulse based on a signal output from the front photo detector, compare the delay with a predetermined reference value, and if the delay is larger than the predetermined reference value, and control the optical driving unit to adjust the recording pulse through a pulse of a reserved output channel to compensate the delay at the upward transition.

10. The optical disc device of claim 9, wherein the controller, if the delay is larger than the predetermined reference value, is configured to adjust timing of the recording pulse by controlling the optical driving unit.

11. The optical disc device of claim 9, wherein the optical driving unit comprises three output channels and drives the laser diode by combining pulses generated at two output channels and outputting a castle-shaped recording pulse; and if upward transition is delayed for laser diode output driven by a recording pulse from the two output channels, additionally uses a reserved output channel.

12. The optical disc device of claim 11, wherein the controller is configured to control the optical driving unit to adjust a recording pulse by generating a pulse with a predetermined level and width at around upward transition of the castle-shaped recording pulse from the reserved output channel.

13. The optical disc device of claim 9, wherein the controller is configured to repeat operation, for multiple output levels of the laser diode, of detecting the amount of delay, comparing the detected delay with a reference value, and adjusting a recording pulse; and stores the adjusted recording pulse in memory.
